(19) United States
(12) Patent Application Publication
(10) Pub. No.: US 2012/0039570 A1
(43) Pub. Date: Feb. 16, 2012

(54) Optical Receptacle and Optical Transceiver Module Using the Same

(75) Inventors: Toshiyuki MATSUMOTO, Kitami-shi (JP); Takashi YAMAMOTO, Kitami-shi (JP)

(73) Assignee: KYOCERA CORPORATION, Kyoto-shi (JP)

(21) Appl. No.: 13/075,005

(22) Filed: Mar. 29, 2011

(30) Foreign Application Priority Data
Aug. 10, 2010 (JP) 2010-179419
Dec. 25, 2010 (JP) 2010-288992

(51) Int. Cl. G02B 6/36; G02B 6/42

(52) U.S. Cl. 385/78

(57) ABSTRACT

To provide an optical receptacle insulated electrically between the tip section and end section of the optical receptacle so that reduces the possibility of EMI and ESD, the optical receptacle includes a cylindrical sleeve for connecting a plug ferrule; a cylindrical stub ferrule made from an electric insulator, through which an optical fiber is to be inserted, the stub ferrule comprising a front end section inserted into a rear end of the sleeve, and a rear end section formed of a thin section having an outer diameter smaller than that of the front end section; a first holder made of a metal fastened on the stub ferrule at a position located toward the front end section from the thin section; and a second holder made of a metal fastened on the thin section.

### BACKGROUND OF THE INVENTION

1. Field of the Invention

The present invention relates to an optical receptacle used in a junction between optical fibers, and an optical transceiver module that uses the optical receptacle and has a light emitting element or a light receiving element provided inside thereof, the optical receptacle designed in consideration of electromagnetic interference and the like, and optical transceiver module using the same.

2. Description of the Related Art

In optical communications using optical fibers, an optical transceiver module comprising an optical transmitter/receiver circuit incorporated in a compact package is used. The optical transmitter/receiver circuit has a light emitting element such as a laser diode or a light receiving element such as a photodiode. The optical transceiver module includes an optical receptacle mounted in a casing thereof. Communications with a mating optical transceiver module is enabled by connecting an optical fiber to the optical receptacle.

FIG. 8 is a sectional view schematically showing the structure of a conventional optical transceiver module. The conventional optical transceiver module 50 has an optical receptacle 30 and an optical device unit 40.

The optical device unit 40 has an optical device 41 such as light emitting element or light receiving element and a peripheral circuit thereof accommodated in a package. The package is composed of a device holder 42 and a device cover 43. The device cover 43 has a window 43a, so that optical signals are transmitted via the window 43a. An alignment adapter 44 is bonded onto the outer surface of the device cover 43 surrounding the window 43a. The alignment adapter 44 holds a holder 37 of the optical receptacle 30.

The optical receptacle 30 has a stub ferrule 34, a sleeve 35, a sleeve case 36 and a holder 37.

The stub ferrule 34 is a cylindrical member having a small hole through which the optical fiber is inserted. The stub ferrule 34 is formed by processing ceramics such as zirconia ceramics or alumina ceramics, metals such as stainless steel (SUS) or plastic materials such as an epoxy resin.

The sleeve 35 has a cylindrical shape and a tip section of the stub ferrule 34 inserted into one end thereof. The other end of the sleeve 35 is provided to insert a tip section of a plug ferrule (not shown) similar to the stub ferrule 34. As both ferrules are inserted on both ends of the cylindrical configuration, faces in the tip of the stub ferrule 34 and the plug ferrule come into contact with each other, so that the optical fibers disposed at the center axis of the ferrules are connected with each other. The sleeve case 36 is provided at the outside of the sleeve 35 for protecting the sleeve 35.

The rear end section of the stub ferrule 34 is press-fitted into the holder 37 and is held thereby. The holder 37 is a hollow member of cylindrical or annular configuration, and is usually formed of a metallic material. The holder 37 is aligned so as to couple the optical fiber in the holder 37 to the optical signals from the optical device 41, and then is fixed onto the alignment adapter 44 of the optical device unit 40 by welding or the like. The optical transceiver module 50 is completed by fastening the holder 37 and the optical device unit 40.

In the conventional optical receptacle 30, the sleeve case 36 and the holder 37 are usually formed of metal such as SUS to meet requirements related to mechanical properties such as rigidity and load bearing capability. Similarly, the device holder 42, the device cover 43 and the alignment adapter 44 of the optical device unit 40 are usually formed of metal. The device holder 42 may be connected to a ground or a supply voltage of the optical device 41 or the peripheral circuit thereof in some cases. In this case, the entire outer casing of the optical transceiver module 50 including the optical receptacle 30 assumes the same potential as that of the ground or the supply voltage of the optical device 41 or the peripheral circuit thereof.

Electric noise generated in the optical device 41 or the peripheral circuit thereof propagates to the optical receptacle 30. This may cause the receptacle 30 to act as an antenna and the noise to be transmitted in the form of electromagnetic waves to the surrounding space from the optical receptacle 30. Conversely, the optical receptacle 30 may act as a receiving antenna to catch extraneous noise, thus affecting the operation of the optical device 41 in some cases. There have been cases where the conventional optical transceiver module 50 suffers from this problem of electromagnetic interference (EMI). There was also such a problem that the electronic circuit of the optical device 41 or the like may fail due to electrostatic discharge (ESD), a static electricity accumulated in a human body or other object is discharged to the optical receptacle 30 that is exposed to the outside.

To mitigate the problems described above, an optical receptacle 31 having a structure shown in FIG. 9 has been proposed. In the optical receptacle 31 shown in FIG. 9, a holder made of metal that holds the stub ferrule 34 formed from ceramic is divided into a first holder 37 and a second holder 38. The first holder 37 and the second holder 38 are electrically isolated from each other by the stub ferrule 34 disposed therebetween (see, for example, JP-A-2007-133225). Thereby, the problems of EMI and ESD are less likely to occur even when the second holder 38 and the alignment adapter 44 are welded together, because the optical device unit 40 is insulated from the sleeve case 36 and the first holder 37 of the optical receptacle 31.

However, a metal track caused by friction may be left on the surface of the stub ferrule 34 as the first holder 37 and the stub ferrule 34 rub against each other, when the first holder 37 is press-fitted into the stub ferrule 34 on the rear end thereof. If the second holder 38 is press-fitted into the stub ferrule 34 on the rear end thereof in this situation, electrical continuity may be formed between the first holder 37 and the second holder 38 via the metal track caused by friction left on the surface.

To prevent this problem, it has been proposed to provide a groove 34c by cutting along the outer circumference of the stub ferrule 34 at a position intermediate between the first holder 37 and the second holder 38 as shown in FIG. 9. According to this proposal, the bottom surface of the groove 34c does not contact the inner circumferential surface of the first holder 37, when the first holder 37 is press-fitted into the stub ferrule 34. As a result, the metal track is interrupted by the grove 34c, so that the problem of electrical continuity formed between the first holder 37 and the second holder 38 via the metal track is eliminated.

However, if a metal track is deposited on the outer circumferential surface of the stub ferrule 34, wherein the second holder 38 is to be press-fitted in, the force of inserting the second holder 38 may not be stabilized, thus resulting in unstable holding of the second holder 38.

Also there is such a problem that, when the groove 34c is formed midway in the axial direction on the outer circumferential surface of the stub ferrule 34, because the diameter at the groove 34c reduces, bending strength in the axial direction decreases. Therefore, during the operation of press-fitting the stub ferrule 34 into the first holder 37 and the second holder 38, force may be concentrated in corners 34d on both sides of the groove 34c, micro-cracks in the corners 34d may be generated. If bending stress is concentrated in the region of the circulating groove 34c when handling the optical transceiver module 50, for example, bonding the optical receptacle 31 to the optical device unit 40 by YAG welding or the like, the stub ferrule 34 may be broken in the portion of the groove 34c. This problem becomes particularly conspicuous in the case of optical receptacle 31 of LC type (a type of which plug ferrule 34 is 1.249 mm in diameter).

### SUMMARY OF THE INVENTION

In light of the problems described above, an object of the present invention is to provide an optical receptacle that reduces the possibility of EMI and ESD problems by insulating electrically the tip section of the optical receptacle from the side of the optical device unit. An ancillary object of the present invention is to provide an optical receptacle that suppresses the deterioration of the mechanical strength for bending stress.

An optical receptacle according to one embodiment of the present invention includes a cylindrical sleeve for connecting a plug ferrule; a cylindrical stub ferrule made from an electric insulator, through which an optical fiber is to be inserted, the stub ferrule comprising a front end section inserted into a rear end of the sleeve, and a rear end section formed of a thin section having an outer diameter smaller than that of the front end section; a first holder made of a metal fastened on the stub ferrule at a position located toward the front end section from the thin section; and a second holder made of a metal fastened on the thin section.

Preferably, the stub ferrule has a tapered section between the front end section and the thin section.

Preferably, the thin section has a protrusion formed to define a fixing position where the second holder is put into contact with the protrusion and is fastened.

Preferably, in the optical receptacle, a contact face perpendicular to an axis of the stub ferrule is formed between the tapered section and the thin section to contact with the second holder.

Also in the optical receptacle, it is preferable that the second holder has a transition surface between an inner circumferential surface making contact with the thin section and a end surface that is adjacent to the inner circumferential surface and is positioned on the front end section side of the stub ferrule.

In an optical receptacle, a stub ferrule through which an optical fiber is to be inserted; a first holder made of a metal having a first inner diameter; and a second holder made of a metal having an second inner diameter smaller than the first inner diameter of the first holder; wherein the first holder and the second holder are fitted onto an outer circumference of a stub ferrule.

In an optical transceiver module according to one embodiment of the present invention, an optical device unit having a light emitting element or a light receiving element is fastened on the second holder of any of the optical receptacles described above.

In the optical receptacle according to one embodiment of the present invention and an optical transceiver module using the same, the first holder made of metal having a large inner diameter is fastened onto the outer circumference of the plug ferrule at a position on the front end section side from the thin section, and the metallic second holder having small inner diameter is fitted onto the thin section. When the first holder is press-fitted onto the plug ferrule, strong rubbing does not occur between the first holder and the outer circumference of the thin section in the plug ferrule. Therefore, possibility of such a problem that electrical continuity is formed between the first holder and the second holder by a metal track caused by friction can be reduced because of the thin section.

### BRIEF DESCRIPTION OF THE DRAWINGS

FIG. 1 is a sectional view showing an optical receptacle according to one embodiment of the present invention.

FIGS. 2A to 2C are enlarged side views showing principal portion of another embodiment of the optical receptacle shown in FIG. 1.

FIGS. 3A to 3D are perspective views showing example of each embodiment of the stub ferrule in the optical receptacle shown in FIG. 1.

FIG. 4 is a sectional view showing an optical receptacle according to another example of the embodiment of the present invention.

FIGS. 5A and 5B are enlarged side views showing principal portion of another embodiment of the optical receptacle shown in FIG. 4.

FIG. 6 is a sectional view showing still another embodiment of the optical receptacle shown in FIG. 4.

FIG. 7 is a sectional view showing an example of embodiment of optical transceiver module of the present invention.

FIG. 8 is a sectional view showing an example of a conventional optical transceiver module.

FIG. 9 is a sectional view showing an example of a conventional optical receptacle.

### DETAILED DESCRIPTION OF THE INVENTION

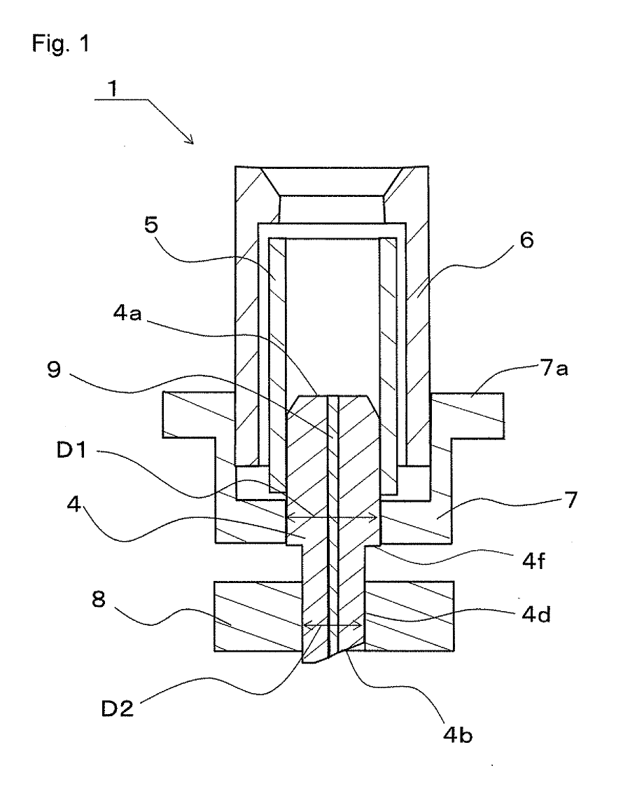

Examples of embodiments of the present invention will be described below with reference to the accompanying drawings. FIG. 1 is a sectional view schematically showing a cross section, including center axis thereof, of the optical receptacle, in an example of the embodiments of the optical receptacle of the present invention. In present embodiment, the optical receptacle 1 is provided with a sleeve 5, stub ferrule 4, a first holder 7 and a second holder 8.

The sleeve 5 has cylindrical shape, with the front end section of the stub ferrule 4 inserted therein on one end (lower end in FIG. 1). The front end section of the stub ferrule 4 refers to a portion including the front end face 4a and having a predetermined length from the front end face 4a toward the rear end of the stub ferrule 4. The tip section of the plug ferrule that the optical fiber passed therethrough is inserted into the other end (upper end in FIG. 1) of the sleeve 5 (not shown), and the tip face of the plug ferrule is put into contact with the front end face 4a of the stub ferrule 4. As a result, the optical fiber 9 aligned in the center axis of stub ferrule 4 and the optical fiber aligned in the center axis of plug ferrule are put into contact in alignment, thus connecting the optical fibers.

The stub ferrule 4 is an electrical insulator having a cylindrical shape and a narrow through hole formed along the center axis. The through hole has the optical fiber 9 passed therethrough over the entire length of the stub ferrule 4. The front end section including the front end face 4a is inserted into one end of the sleeve 5 and thus the sleeve 5 is supported. The stub ferrule 4 has a thin section 4d having smaller diameter D2 formed on the outer circumference thereof in the rear end section including the rear end face 4b.

The metallic first holder 7 is press-fitted and fastened on the outer circumference of the stub ferrule 4 at a position on the front end section located front side for the thin section 4d. The thin section 4d of the stub ferrule 4 has diameter D2, and the section on the front end section side for the thin section 4d has diameter D1 larger than diameter D2. The first holder 7 is inserted to the stub ferrule 4 from the rear end side thereof. While the first holder 7 may be fastened with an adhesive or the like, press-fitting is more preferable from the viewpoint of ease of assembling. The first holder 7 has an inner diameter that can be press-fitted onto the section of the stub ferrule 4 having a diameter D1, and the inner diameter of the first holder 7 is larger than diameter D2 of the thin section 4d, and therefore the thin section 4d and the first holder 7 do not strongly rub against each other during press-fitting operation. Accordingly, metal track caused by friction is less likely to deposit on the thin section 4d when the first holder 7 is press-fitted.

In FIG. 1, the rear end face of the first holder 7 is shown almost flush with the terminal position of the front end side of the thin section 4d, although the rear end face of the first holder 7 may also be fastened at a position nearer to the terminal end position of the thin section 4d, or at a position partially covering the thin section 4d. However, it is preferable to fasten the rear end face of the first holder 7 to be almost flush with the terminal end of the thin section 4d, since it enables it to fasten the first holder 7 most compactly. There are cases where the first holder 7 is connected to the housing or casing of a communication apparatus. Therefore, a fastening section such as flange 7a is often formed on the other end.

To the thin section 4d of the stub ferrule 4, the metallic second holder 8 press-fitted and fastened thereon. The second holder 8 is also fitted on the rear end side of the stub ferrule 4. The second holder 8 may also be fastened with an adhesive or the like, although press-fitting is more preferable from the viewpoint of ease of assembling. The second holder 8 is press-fit to a predetermined position of the thin section 4d. The second holder 8 is typically fastened onto the alignment adapter 24 of the optical device unit 2 by welding or the like.

The sleeve 5 is provided with a sleeve case 6 attached to the outside thereof for the purpose of protecting the sleeve 5 and preventing the sleeve 5 from coming off the stub ferrule 4. The sleeve case 6 is typically made of a metal from the viewpoint of mechanical properties such as strength, and is fastened to the first holder 7 by press-fitting or the like.

The first holder 7 and the second holder 8 fastened on the circumference surface of the stub ferrule 4 on the front end 4a side and the rear end 4b side, respectively, are separately disposed on the thin section 4d having a diameter D2 and on the front end section side having a diameter D1, respectively, and are therefore fastened while being electrically isolated from each other. The front end side section and the thin section 4d of the stub ferrule 4 are separated from each other by the intervening step section 4f.

The first holder 7 and the second holder 8 are usually fastened by press-fitting on the stub ferrule 4. Because the stub ferrule 4 is formed to have the thin section 4d, it is possible to avoid a problem that a metal track or a metal deposits on the stub ferrule 4 caused by friction due to the first holder 7 being press-fitted onto the stub ferrule 4 as the first holder 7 and the stub ferrule 4 rub against each other. FIG. 1 exaggerates the difference between outer diameter D2 of the thin section 4d and outer diameter D1 of the front end side of the stub ferrule 4. However, as is apparent from the description above, it suffices to set the outer diameter D2 of the thin section 4d to such a value as the first holder 7 and the outer circumference of stub ferrule 4 do not rub strongly against each other, when the first holder 7 is press-fitted.

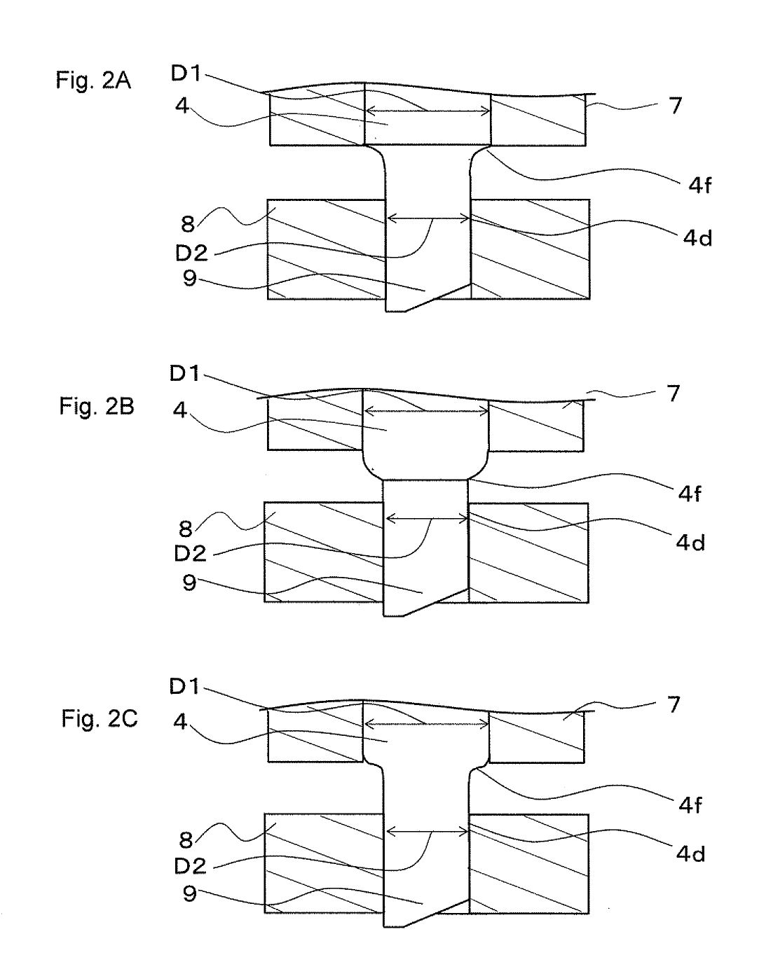

FIGS. 2A to 2C are partially enlarged views showing examples of step section 4f shape located between the section having a diameter D1 and the thin section 4d of the stub ferrule 4. The first holder 7 and the second holder 8 are shown in sectional views, and the stub ferrule 4 is shown in side view depicting the outer circumference. While FIGS. 2A to 2C show several examples of the shape of the step section 4f formed between the section having a large diameter D1 and the thin section 4d in the stub ferrule 4, the step section 4f is not limited to these shape and may be formed in other shape.

FIG. 2A shows an example where a curved tapered section is provided between the step section 4f and the thin section 4d. In this example, the corner on the thin section 4d side is rounded by forming a concave curved surface around the center axis of the stub ferrule 4 extending between the thin section 4d and the step section 4f.

FIG. 2B shows an example where shoulder of section having larger diameter is rounded into a convex curved tapered section with respect to the center axis of the stub ferrule 4, between the section having a large diameter D1 and the step section 4f.

FIG. 2C shows an example where the corners formed on both sides of the step section 4f are rounded in curved tapered shape by combining the curved surfaces shown in FIGS. 2A and 2B.

It is made possible to distribute the bending stress around the taper that would otherwise be concentrated in the stub ferrule 4 thereby making it less prone to breakage, by providing the taper between the front end section having a diameter D1 and the thin section 4d of the stub ferrule 4, as in these examples.

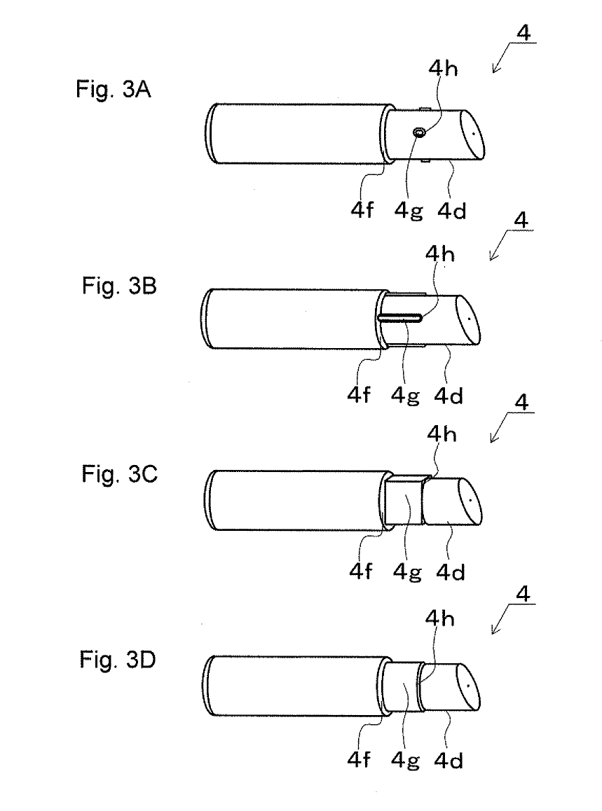

FIGS. 3A to 3D are perspective views showing examples of the shape of the thin section 4d of the stub ferrule 4. In these examples, the thin section 4d has a protrusion 4g having a contact face 4h which makes contact with the front end section of the second holder 8. The protrusion 4g in FIG. 3A protrudes at a mid position of the thin section 4d where the second holder 8 is to be fastened. The protrusion 4g in FIG. 3B is a ridge that connects between the positions where the second holder 8 is to be fastened and the step section 4f. The protrusion 4g in FIG. 3C is formed in a polygonal prism extending between the position where the second holder 8 is to be fastened and the step section 4f. The protrusion 4g in FIG. 3D is formed in cylindrical shape concentric with the thin section 4d extending between the position where the second holder 8 is to be fastened and the step section 4f.

The protrusions 4g shown in FIGS. 3B, 3C and 3D are formed with such a height that does not rub against the inner surface of the through hole of the first holder 7. Shapes of the protrusions 4g shown in FIGS. 3B to 3D illustrate an example thereof and are not limited thereto, and shapes other than these may also be employed.

Providing the protrusion 4g enables it to increase the mechanical strength of the stub ferrule 4 against bending stress.

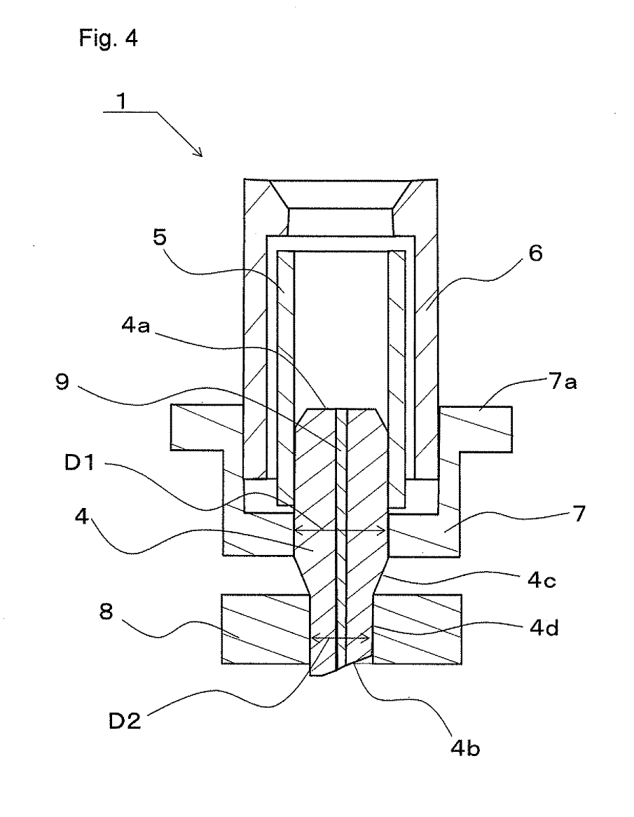

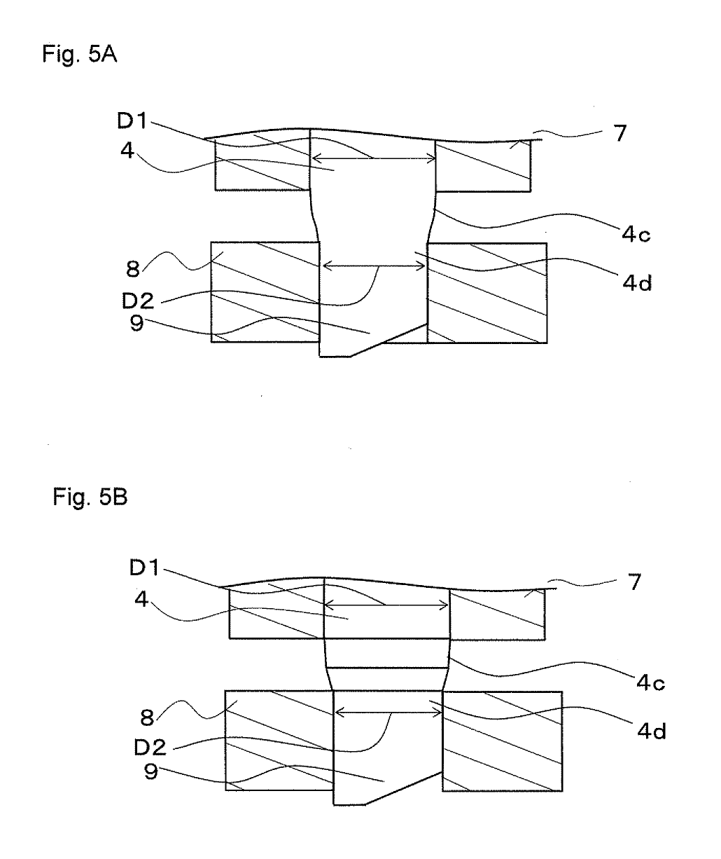

FIG. 4 shows the optical receptacle 1 of an example where a tapered section 4c is provided between the front end side section having a diameter D1 and the thin section 4d of the stub ferrule 4. FIGS. 5A and 5B are partially enlarged views showing examples of the shape of tapered section 4c. In FIGS. 5A and 55, the first holder 7 and the second holder 8 are shown in sectional view and the stub ferrule 4 is shown in side view depicting the outer circumference thereof.

The tapered section 4c may have, besides the shape that linearly tapers off as shown in FIG. 4, the convex curved shape bulging toward the outside of the stub ferrule while tapering off toward the thin section 4d as shown in FIG. 5A, or the concave curved shape that tapers off. The tapered section 4c may also be formed from a plurality of surfaces inclining at different angles, as shown in FIG. 55.

In FIG. 4, the first holder 7 is fastened at almost the same position as the end of the tapered section 4c, although it may also be fastened at a position nearer to the front end section side of the stub ferrule 4 of the terminal end of the tapered section 4c, or at a position partially covering the tapered section 4c. However, it is preferable to fasten the first holder 7 at almost the same position as the end of the tapered section 4c, since it enables it to fasten the first holder 7 most compactly.

Providing the tapered section 4c between the section having larger diameter D1 and the thin section 4d in the stub ferrule 4 mitigates the stress concentration when the stub ferrule 4 is loaded in the bending direction, thus making the stub ferrule 4 less likely to break. Also because the tapered section 4c serves as a guide, it becomes easier to insert the first holder 7 through the rear end side of the stub ferrule 4. The tapered section 4c may also be used as a positioner for the second holder 8 by providing the tapered section 4c up to position where the second holder 8 is to be fastened. This makes it easier to position the second holder 8 by press-fitting it up to the starting point of the tapered section 4c. It is also made possible to set an appropriate spacing between the first holder 7 and the second holder 8.

Tapering rate of the tapered section 4c may be determined from the difference between the outer diameter D2 of the thin section 4d and the outer diameter D1 of the tip side of the stub ferrule 4, and the isolating distance or the distance along the surface between the first holder 7 and the second holder 8.

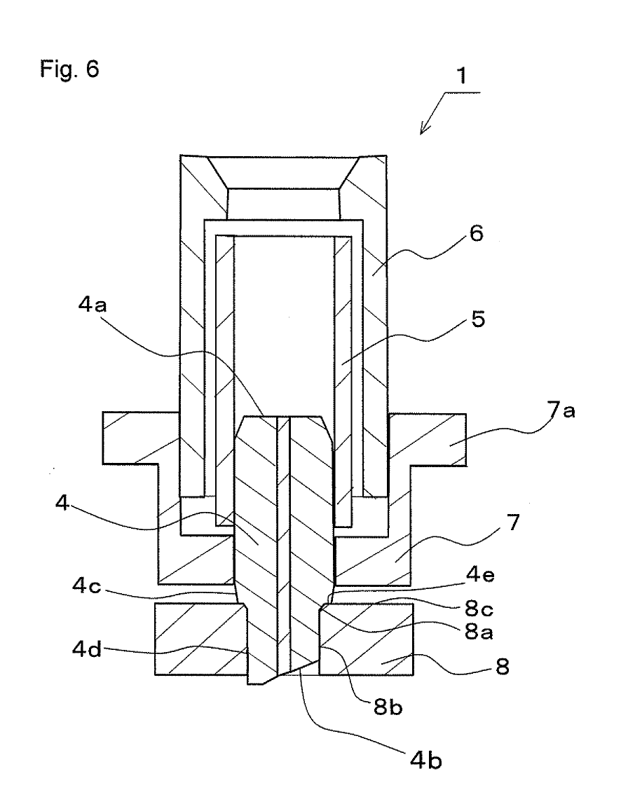

FIG. 6 is a sectional view showing further another embodiment of the optical receptacle 1 shown in FIG. 4. In FIG. 6, a contact face 4e perpendicular to the longitudinal axis of the stub ferrule 4 is provided between the tapered section 4c and the thin section 4d, and the second holder 8 is fastened in contact with the contact face 4e. The structure having the second holder 8 in contact with the outer circumference of the thin section 4d and with the contact face 4e makes it possible, similarly to the contact face 4h of the protrusion 4g shown in FIG. 3, to reduce the bending stress generated in the thin section 4d by the contact face 4e when such an extraneous force is applied to the stub ferrule 4 as the second holder 8 is loaded in the bending direction. As a result, possibility of the stub ferrule 4 to break can be reduced.

It is preferable to form a transition surface 8a or an obliquely transition surface 8a or a curved transition surface 8a along the opening of the through hole 8b of the second holder 8, as shown in FIG. 6, or the second holder 8 to be put into contact with the contact face 4h of the protrusion 4g shown in FIG. 3. The transition surface 8a or an obliquely transition surface 8a or a curved transition surface 8a is provided between the inner circumferential surface of the through hole 8b and the surface 8c on the front end section side of the stub ferrule 4 adjacent to the inner circumferential surface, namely the surface in contact with the contact face 4e. This enables it to achieve more secure contact between the contact face 4e and the surface 8c, even when the tapered shape is formed between the step section 4f and the thin section 4d. Moreover, it becomes easier to press-fit the second holder 8 as the edge of the second holder 8 does not scrape the outer circumference surface of the stub ferrule 4 in the case of press-fitting the second holder 8. Therefore, it is prefer able to provide the transition surface 8a on the second holder 8 in any embodiment shown herewith. The transition surface 8a can be formed such as by cutting out a opening of the through hole 8b

When a hole formed in a metal with a dielectric material filled therein, radio signal having frequency more than a certain frequency may propagate through the hole. However, in the optical receptacle according to one embodiment of the present invention, as described above, the first holder 7 having hole diameter D1 attached to the housing side of the optical communication apparatus and the second holder 8 having hole diameter D2 smaller than a hole diameter D1 fastened on the optical device unit 2 are disposed near to each other, both being penetrated by the stub ferrule 4 that is formed from a dielectric material. Therefore, the first holder 7 and the second holder 8 exhibit different impedances to the radio signals, thereby providing an effect of making it difficult for the radio signals to propagate through the hole. It is also made possible to partially reflect on the portion of the second holder 8 having the small diameter D2. In particular, the optical receptacle 1 shown in FIG. 6 allows it to determine the size of the diameter D2 of the second holder 8 to the diameter D1 of the first holder 7 relatively freely, and is preferable for such a design.

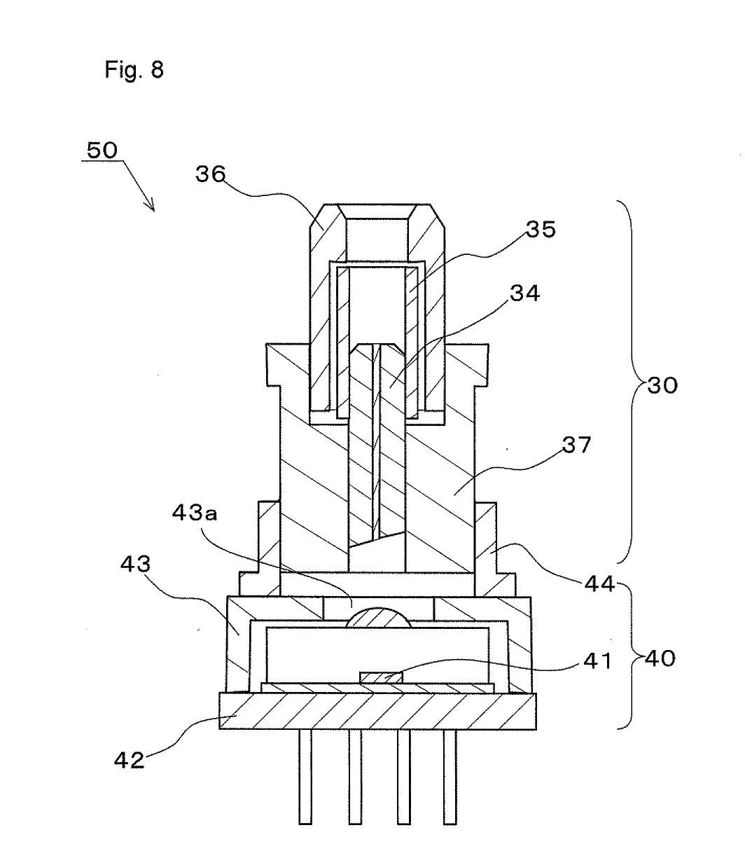

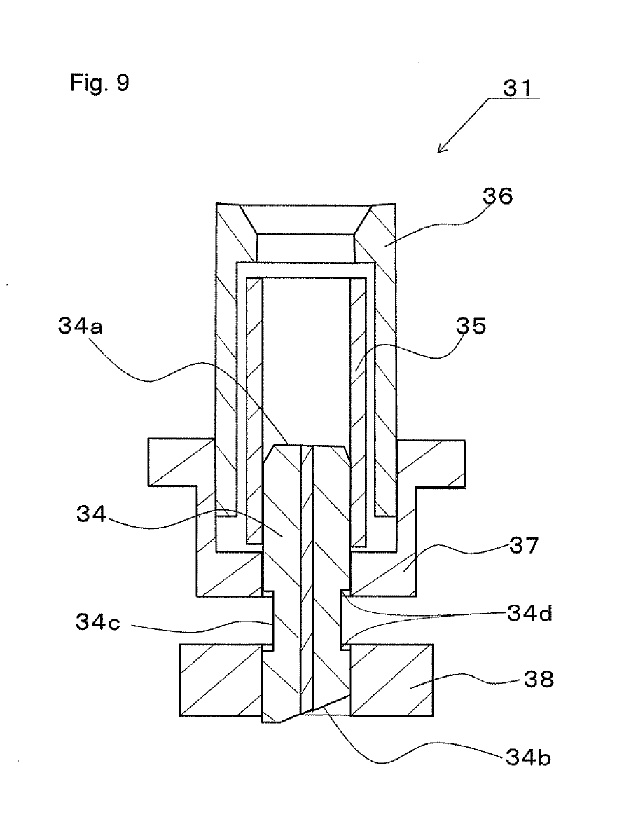

In the optical transceiver 3, outer diameter D1 of the tip side of the stub ferrule 4 is determined by the outer diameter of the plug ferrule of the optical connector to be inserted therein. Outer diameter of the plug ferrule to be inserted is about 1.25 mm for optical connectors commonly referred to as type MU or LC, about 2.5 mm for optical connectors commonly referred to as type SC, FC or ST, and about 2.0 mm for optical connectors commonly referred to as type D4. The stub ferrule 4 having the same outer diameter as that of the plug ferrule is used in order to fit in the sleeve 5. With the optical receptacles 30, 31 of the conventional optical transceiver modules shown in FIG. 8 and FIG. 9, hole diameters of the holder 37 and the holder 38 are comparable to the outer diameter of the stub ferrule 34, and cannot be set individually to a proper inner diameter.

The stub ferrule 4 is formed from an electrically insulating material such as plastics such as epoxy resin or liquid crystal polymer, or ceramics such as alumina ceramic or zirconia ceramic. It is particularly preferable to use zirconia ceramic from the viewpoint of mechanical properties. Specifically, it is preferable to use partially stabilized zirconia ceramic that contains ZrO₂ as the main component and at least one of Y₂O_{3, CaO, MgO, CeO}₂, Dy₂O₃ and the like as a stabilizer, and is also mainly composed of crystals such as tetragon. Such a partially stabilized zirconia ceramic has excellent wear resistance and undergoes elastic deformation to some extent, and is advantageous for fastening the metal holders 7, 8 by press-fitting.

The stub ferrule 4 is manufactured as follows. In case it is formed from zirconia ceramic, for example, a compact having a cylindrical or rectangular parallelepiped shape is formed from a raw zirconia ceramic material by injection molding, press molding, extrusion molding or other molding method, fired at a temperature from 1,300° C. to 1,500° C., and then subjected to a cutting or polishing operation to obtain the outer surface of the stub ferrule 4 having the predetermined dimensions. The compact before firing may also be formed into the predetermined shape in advance by a cutting operation or the like, and then subjected to firing.

The front end face 4a of the stub ferrule 4 is formed in a curved surface having a radius of curvature in a range from 5 mm to 30 mm, in order to reduce the joining loss caused by connection with the plug ferrule of the optical connector. The rear end face 4b is polished into a mirror grade surface inclined by about 4 to 10 degrees from the surface perpendicular to the axis of the stub ferrule 4, in order to prevent the light emitted from an optical device 21 such as laser diode (LD) from being reflected on the end face of the optical fiber and returning of the reflected light to the optical device 21.

Because the stub ferrule 4 is formed to have inclined rear end face 4b, the press-fitting is performed to insert rear end face 4b into the through hole of the first holder 7 and the second holder 8 pressing the front end face 4a of the stub ferrule 4.

The sleeve 5 is formed from such a material as zirconia ceramic, alumina ceramic or copper. Ceramic material such as zirconia ceramic is usually used mainly taking account of wear resistance. The sleeve is manufactured as follows. In case it is formed from a ceramic material such as zirconia, a compact having a tubular or cylindrical shape of the sleeve 5 is formed by a predetermined molding method such as injection molding, press molding or extrusion molding method in advance, fired at a temperature from 1,300° C. to 1,500° C., and then subjected to a cutting or polishing operation to obtain the predetermined dimensions, similarly to the case of the stub ferrule 4 described above. The compact may also be formed into the predetermined shape by cutting operation or the like in advance, and then subjecting to firing.

Roughness of the inner surface of the sleeve 5 is preferably 0.2 μm or less in terms of arithmetic mean roughness (Ra) in consideration of the ease of insertion, and difference between the outer diameter of the stub ferrule 4 and the inner diameter of the sleeve 5 is preferably ±1 μm or less so as to decrease the joining loss. The inner diameter of the sleeve 5 is preferably set to such a size as a insertion force of 0.98 N or more, so that the stub ferrule 4 can be held securely.

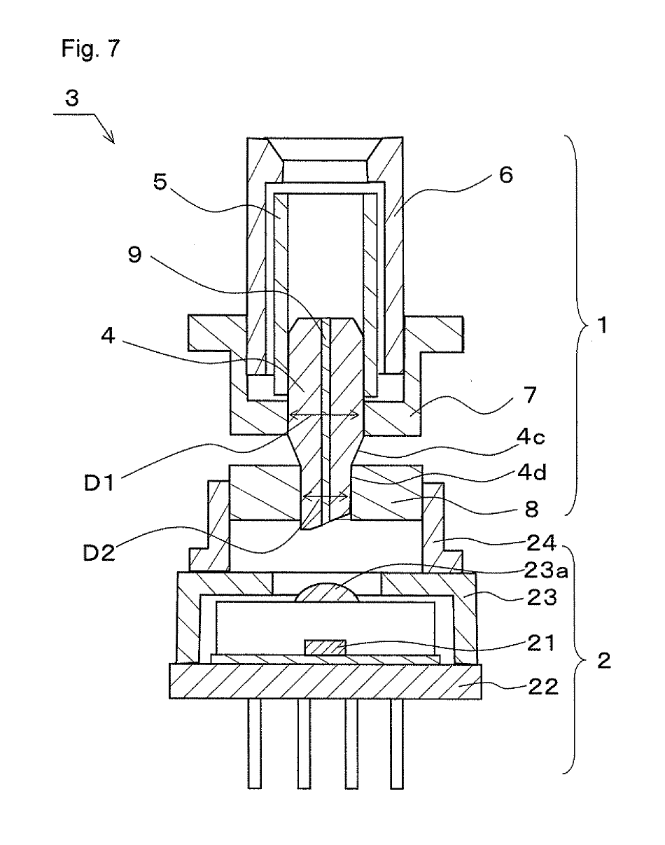

The stub ferrule 4 is fastened by press-fitting or bonding it in the first holder 7 and the second holder 8, or combining press-fitting and bonding. Also since the second holder 8 on the rear end side is often welded onto the alignment adapter 24 of the optical device unit 2 as shown in FIG. 7, it is formed from a metallic material such as stainless steel, copper, iron or nickel that can be welded. Stainless steel is commonly used taking account of corrosion resistance and weldability.

Further, the first holder 7 and the sleeve case 6 do not take account of weldability and therefore can be formed from a wide range of materials such as stainless steel, copper, iron, nickel, plastics, zirconia ceramic and alumina ceramic. Usually, stainless steel is used taking account of corrosion resistance, similarly to the second holder 8.

As described above, the optical receptacle 1 according to one embodiment of the present invention shown in FIG. 1 to FIG. 6 has such a structure as the first holder 7 and the second holder 8 having different inner diameters are fastened onto diameter D1 of the front end 4a section of the stub ferrule 4 and the thin section 4d of diameter D2 of the rear end 4b side, respectively. This enables it to ensure electrical isolation between the first holder 7 and the second holder 8, stably hold the second holder 8 and provide the optical receptacle 1 that endures the bending load applied to the stub ferrule 4. In addition, it is made possible to freely set the inner diameter D2 of the second holder 8 fastened on the optical device unit 2, and suppress radio noise from entering.

FIG. 7 is a sectional view showing an example of the optical transceiver module 3 having the optical receptacle shown in FIG. 4, as a typical example among the optical receptacles of various types described above. In the example of the embodiment shown in FIG. 7, the optical transceiver module 3 is constituted by fastening the optical receptacle 1 to the optical device unit 2 having the optical device 21. A light emitting element such as LD (laser diode) or a light receiving element such as PD (photo diode) is used as the optical device 21.

The optical device unit 2 has the optical device 21 accommodated in a housing comprising a device holder 22 and a device cover 23. The device cover 23 has a window 23a, so that optical signals are exchanged with the outside via the window 23a. The alignment adapter 24 is bonded onto the outer surface of the device cover 23 surrounding the window 23a. The alignment adapter 24 holds the second holder 8 of the optical receptacle 1 as the alignment adapter 24 and the second holder 8 are aligned so that the optical device 21 and the optical fiber 9 are optically connected and then welded together.

In the optical transceiver module 3 according to one embodiment of the present invention, the optical device unit 2 is electrically isolated from the first holder 7 made of metal and the sleeve 6 each other by the stub ferrule 4, so that radio noise is less likely to interfere. Also it is made possible to stabilize holding of the first holder 7 and the second holder 8 and make the stub ferrule 4 less prone to breakage.

### Examples

Examples of the present invention will be described below.

First, an LC type optical receptacle 1 having a structure shown in FIG. 6 as an example of the present invention and an LC type optical receptacle of conventional structure shown in FIG. 9 for comparison were manufactured.

The stub ferrules 4, 34 used in each optical receptacle 1, 31 are made from zirconia ceramics and were manufactured by firing cylindrical ceramic compacts formed by extrusion molding and subjecting to a cutting operation.

Optical fibers were fastened by inserting into the through holes of the respective stub ferrules 4, 34 thus obtained, and the front end faces 4a, 34a were polished to obtain curved mirror surfaces having a radius of curvature of about 12 mm. The rear end faces 4b, 34b on the opposite side were polished to obtain mirror surface inclined by 8 degrees in order to prevent the light emitted from the optical device such as LD from being reflected on the tip section of the optical fiber and returning of the reflected light to the optical device.

Then the first holders 7, 37 were fastened by press-fitting on the tip sides of the stub ferrules 4, 34 and the second holders 8, 38 were similarly fastened by press-fitting on the rear end sides. Further, the sleeves 5, 35 were inserted into the tip section of the stub ferrules 4, 34 and the sleeve cases 6, 36 were press-fitted on the first holders 7, 37 thereby making the optical receptacles 1, 31. Breaking load on the stub ferrules 3, 34 was measured by applying bending load to the fastened second holders 8, 38 which is fastened on the optical device unit side of the respective optical receptacles 1, 31.

TABLE 1

| | Structure of the | Structure of the |
|---|---|---|
| No. | present invention | prior art |
| 1 | 105 | 64 |
| 2 | 99 | 60 |
| 3 | 108 | 58 |
| 4 | 110 | 57 |
| 5 | 92 | 70 |
| 6 | 109 | 69 |
| 7 | 98 | 61 |
| 8 | 103 | 63 |
| 9 | 101 | 55 |
| 10 | 100 | 65 |
| Average | 103 | 62 |
| Maximum | 110 | 72 |
| Minimum | 92 | 55 |

As is apparent from Table 1, a bending breaking load of the optical receptacle 1 according to one embodiment of the present invention is from 92 N to 110 N, more than 55N to 72N of the breaking load of the conventional optical receptacle 34, and that load bearing capability could be improved.

What is claimed is:

1. An optical receptacle comprising:
a cylindrical sleeve for connecting a plug ferrule;
a cylindrical stub ferrule made from an electric insulator, through which an optical fiber is inserted, the stub ferrule comprising a front end section inserted into a rear end of the sleeve, and a rear end section formed of a thin section having an outer diameter smaller than that of the front end section;
a first holder made of a metal fastened on the stub ferrule at a position located toward the front end section from the thin section; and
a second holder made of a metal fastened on the thin section.

2. The optical receptacle according to claim 1,
wherein the stub ferrule has a tapered section between the front end section and the thin section.

3. The optical receptacle according to claim 1,
wherein the thin section has a protrusion to define a fixing position where the second holder is put into contact with the protrusion and is fastened.

4. The optical receptacle according to claim 1,
wherein a contact face perpendicular to an axis of the stub ferrule is formed between the tapered section and the thin section to contact with the second holder.

5. The optical receptacle according to claim 1,
wherein the second holder has a transition surface between an inner circumferential surface making contact with the thin section and a end surface that is adjacent to the inner circumferential surface and is positioned on the front end section side of the stub ferrule.

6. The optical receptacle according to claim 3,
wherein the second holder has a transition surface between an inner circumferential surface making contact with the thin section and a end surface that is adjacent to the inner circumferential surface and is positioned on the front end section side of the stub ferrule.

7. The optical receptacle according to claim 4,
wherein the second holder has a transition surface between an inner circumferential surface making contact with the thin end section and a surface that is adjacent to the inner circumferential surface and is positioned on the front end section side of the stub ferrule.

8. An optical receptacle comprising:
a stub ferrule through which an optical fiber is inserted;
a first holder made of a metal having a first inner diameter; and
a second holder made of a metal having an second inner diameter smaller than the first inner diameter of the first holder;
wherein the first holder and the second holder are fitted onto an outer circumference of the stub ferrule.

9. A transceiver module wherein an optical device unit having a light emitting element or a light receiving element is fastened on the second holder of the optical receptacle as in claim 1.

10. A transceiver module wherein an optical device unit having a light emitting element or a light receiving element is fastened on the second holder of the optical receptacle as in claim 8.
